(19) United States
(12) Patent Application Publication
(10) Pub. No.: US 2004/0146251 A1
(43) Pub. Date: Jul. 29, 2004

(54) Optical connector

(75) Inventor: Takamichi Kudo, Susono-shi (JP)

Correspondence Address: SUGHRUE MION, PLLC, 2100 PENNSYLVANIA AVENUE, N.W., SUITE 800, WASHINGTON, DC, 20037, US

(73) Assignee: YAZAKI CORPORATION

(21) Appl. No.: 10/696,569

(22) Filed: Oct. 30, 2003

(30) Foreign Application Priority Data
Oct. 30, 2002 (JP) P2002-316500

(51) Int. Cl. G02B 6/36

(52) U.S. Cl. 385/88

(57) ABSTRACT

An optical connector includes a light emitting module, emitting an optical signal, an optical fiber, propagating the optical signal, and a lens sleeve, interposed between the light emitting module and the optical fiber so as to optically connect the light emitting module and the optical fiber. The light emitting module includes a light emitting element having a small emission angle.

### BACKGROUND OF THE INVENTION

This invention relates to an optical connector in which a lens sleeve, optically connecting an optical fiber and a light receiving/emitting module together, and the lens sleeve interposed between the optical fiber and the light receiving/emitting module, and more particularly to an optical connector for mounting on a vehicle.

For example, one known related optical connector is disclosed in JP-A-2002-023024.

As shown in FIG. 3, the related optical connector 50 includes a receptacle (equipment-side connector) 51, and an optical plug (optical fiber-side connector) 52. The optical plug 52 includes a pair of parallel optical fibers 53, a plug housing 54, and a spring cap 55. A pair of ferrules are provided within the plug housing 54.

The optical fiber 53 includes a core 53a and a clad 53b which are different in refractive index from each other, and are disposed coaxially with each other.

The receptacle 51 includes a housing 56 made of a synthetic resin or the like, and a receiving device 57 (shown in FIG. 4) serving as a receiving module, a transmitting device 58 (shown in FIG. 5) serving as a transmitting module, and a pair of sleeves 59.

As shown in FIGS. 4 and 5, the housing 56 has a box-like shape, and includes a pair of receiving chambers 60, and a pair of support cylinders 61 communicating respectively with the receiving chambers 60. Each receiving chamber 60 communicates with the corresponding support cylinder 61 through an opening.

The support cylinders 61 have a cylindrical shape, and are disposed parallel to each other. The support cylinders 61 are disposed parallel to the optical axes of the receiving and transmitting devices 57 and 58 (received respectively in the receiving chambers 60), respectively.

A step portion 63 is formed between the receiving chamber 60 and the support cylinder 61, and a flange portion 62 of the sleeve 59, received in the support cylinder 61, abuts against the step portion 63.

The receiving device 57 and the transmitting device 58 are received in the receiving chambers 60, respectively. The receiving device 57 converts a received optical signal into an electrical signal, and has a light-receiving surface 64 for receiving the optical signal.

The transmitting device 58 converts an electrical signal into the optical signal, and has a light-emitting surface 65 for emitting the optical signal.

The sleeve 59 includes a light guide passage 67 of a truncated cone-shape which is decreasing in diameter gradually in a direction away from the optical fiber 53 toward the receiving device 57/the transmitting device 58, and has a tapering side portion 66, an outer-periphery-projected portion 68, an outer tubular portion 69, and the flange 62, these portions being formed integrally with one another.

An end face 70 which is reduced in diameter at the light guide passage 67 is smaller than the receiving surface 64 of the receiving device 57, and is larger than the light-emitting surface 65 of the transmitting device 58. The end face 70 is disposed so as to be opposed to the light-receiving surface 64/the light-emitting surface 65. Namely, the end face 70 is optically connected to the receiving device 57/transmitting device 58. The end face 70 defines the smaller end of the light guide passage 67.

An end face 71 of the light guide passage 67, disposed close to a larger end thereof remote from the end face 70, is disposed so as to be opposed to an end face 53c of the optical fiber 53. Namely, the end face 71 is optically connected to the optical fiber 53. A lens 72 at the end face 71 is formed integrally with the light guide passage 67.

The lens 72 convexly projects from the end face 71 toward the optical fiber 53. The lens 72 has a predetermined radius of curvature, and is formed, for example, into a spherical lens. The lens 72 is located in such a position that it does not project beyond the end face of the outer tubular portion 69 disposed close to the optical fiber 53.

The outer-periphery-projected portion 68 projects outwardly from the outer peripheral surface of the light guide passage 67 at the end portion thereof. The outer-periphery-projected portion 68 has an annular shape, and has its center disposed on the optical axis of the light guide passage 67.

The outer tubular portion 69 has a round tube-shape, and extends from an outer edge portion of the outer-periphery-projected portion 68 toward the end face 70, and extends from the outer edge portion of the outer-periphery-projected portion 68 along the optical axis over an entire length of the light guide passage 67.

That end face of the outer tubular portion 69, disposed close to the end face 70, is disposed generally in a plane in which the end face 70 lies. The outer tubular portion 69 has a uniform outer diameter over the entire length thereof along the optical axis, and the axis (centerline) of the outer tubular portion 69 coincides with the optical axis.

The flange portion 62 extends outwardly from the outer peripheral surface of the outer tubular portion 69, and is formed on a central portion of the outer tubular portion 69 in the direction of the optical axis, or is formed on a suitable portion of the outer peripheral surface of the outer tubular portion 69. The flange portion 62 has an annular shape, and has its center disposed on the optical axis. The flange portion 62, the light guide passage 67, the outer-periphery-projected portion 68 and the outer tubular portion 69 are disposed coaxially.

The sleeve 59 is received in the support cylinder 61 such that the lens 72 is opposed to the end face 53c of the optical fiber 53 and that the end face 70 is opposed to the receiving device 57/the transmitting device 58. In this condition, the flange portion 62 abuts against the step portion 63.

The ferrule 73 covers the optical fiber 53 in such a manner that its distal end 74 is disposed at the distal end of the optical fiber.

When the optical signal is transmitted from the optical fiber 53 to the receiving device 57 via the sleeve 59, transmitted rays C1 and C2, propagating through the optical fiber 53 while repeatedly subjected to total reflection, go out of the end face 53c of the optical fiber 53, and enters the sleeve 59 via the lens 72 as indicated by arrows in FIG. 4.

Then, the rays C1 and C2 are condensed while repeatedly subjected to total reflection (since the side portion 66 of the light guide passage 67 is tapering (that is, gradually decreasing in diameter) toward the receiving device 57, and the side portion 66 is disposed in contact with an air layer), and are incident on the light-receiving surface 64 of the receiving device 57.

When light is transmitted from the transmitting device 58 to the optical fiber 53 via the sleeve 59, for example, an LED ray (or a laser beam) C3, emitted from the light-emitting surface 65 of the transmitting device 58, enters the sleeve 59 via the end face 70 of the sleeve 59.

Then, the LED ray C3 propagates in a diffused manner while repeatedly subjected to total reflection (since the side portion 66 of the light guide passage 67 is tapering (that is, gradually decreasing in diameter) toward the transmitting device 58, and the side portion 66 is disposed in contact with an air layer), and reaches the lens 72. Thereafter, the LED ray C3 is condensed by the lens 72, and enters the optical fiber 53 via the end face 53c thereof.

In the above related optical connector 50, in the case where a gap is needed when connecting the sleeve 59 and the optical fiber 53 together, a cut sleeve with a fiber waveguide passage is required for filling up this gap. However, when taking into consideration a clearance at the time of fitting the connector, a gap develops between the cut sleeve and the optical fiber 53, and this can cause increased loss.

In order to deal with this, the Applicant of the present application has proposed the use of a lens sleeve as shown in JP-A-2000-329972 and JP-A-2001-133665 and others. As shown in FIG. 6, light C, emitted from a transmitting device 80 fixedly mounted on a base plate 81 of an optical connector employing the above lens sleeve, is condensed by the lens sleeve 82, and enters an optical fiber 83. The optical connector has dimensional tolerances and clearances when a receptacle and a plug are fitted together, and therefore the optical fiber 82 is movable in an axis direction within the range “a” shown in the drawing.

However, when the lens sleeve 82 as shown in FIG. 6 is used, the numerical aperture is as large as 37 degrees (NA=0.6) in a space L given for the lens sleeve 82 which space is determined in connection with the design of the optical connector, and therefore an overall outer diameter increases, thus inviting a problem that it is difficult to achieve a small diameter.

### SUMMARY OF THE INVENTION

It is therefore an object of the present invention to provide an optical connector in which a broad-band optical transmission can be effected by the use of a glass fiber, and a long-distance transmission and the use of an increased number of intermediate connectors due to a high-output and low-loss design can be achieved, and besides because of its highly thermally-resistant design, the optical connector can be installed at a high-temperature region.

In order to achieve the above object, according to the present invention, there is provided an optical connector, comprising:

a light emitting module, emitting an optical signal;

an optical fiber, propagating the optical signal; and

a lens sleeve, interposed between the light emitting module and the optical fiber so as to optically connect the light emitting module and the optical fiber,

wherein the light emitting module includes a light emitting element having a small emission angle.

Preferably, the optical fiber includes a glass fiber.

Preferably, the light emitting element includes at least one of a resonant cavity light emitting diode, a vertical cavity surface emitting laser and a laser diode.

Preferably, the light emitting element includes at least one of a resonant cavity light emitting diode, a vertical cavity surface emitting laser and a laser diode.

In the above construction, the glass fiber is used, and therefore an optical signal to be inputted into the lens sleeve is reduced into a smaller diameter by a small numerical aperture of the light-emitting module.

Therefore, a cylindrical portion of the lens sleeve can be reduced into a small diameter by using the light emitting module having the small numeral aperture, and besides the radius of curvature of the lens is reduced, thereby achieving the optimum design. Therefore, even when the glass fiber of a small diameter is used, the uniform and efficient inputting of the light can be achieved.

As a result, a broad-band optical transmission can be effected, and a long-distance transmission and the use of an increased number of intermediate connectors due to the high-output and low-loss design can be achieved, and besides because of its highly thermally-resistant design, the optical connector can be installed at a high-temperature region, and can be installed in a narrow space as between roof panels of a vehicle body or in an engine room.

Preferably, the emission angle of the light emitting element is in the range of between 15 degrees and 25 degrees.

Here, it is preferable that, the emission angle of the light emitting element is around 18 degrees.

In the above construction, by using the light-emitting module having the small numerical aperture in the range of between 15 degrees and 25 degrees (including 18 degrees), the cylindrical portion of the lens sleeve can be reduced into a small diameter, and besides the radius of curvature of the lens can be reduced, thereby achieving the optimum design. Therefore, even when the glass fiber of a small diameter is used, the uniform and efficient inputting of the light can be achieved.

As a result, the broad-band optical transmission can be effected, and the long-distance transmission and the use of an increased number of intermediate connectors due to the high-output and low-loss design can be achieved, and besides because of its highly thermally-resistant design, the optical connector can be installed at a high-temperature region, and can be installed in a narrow space as between the roof panels of the vehicle body or in the engine room.

Preferably, the optical fiber is movable relative to the lens sleeve within a predetermined range of a gap.

In the above construction, the lens sleeve is coupled to the glass fiber via the gap of the predetermined size.

Therefore, by using the light-emitting module with the small numerical aperture and the lens sleeve connected to the glass fiber via the gap, the cylindrical portion of the lens sleeve can be reduced into a small diameter, and besides the radius of curvature of the lens can be reduced, thereby achieving the optimum design. Therefore, even when the glass fiber of a small diameter is used, the uniform and efficient inputting of the light relative to the gap of the predetermined size can be achieved.

As a result, the broad-band optical transmission can be effected, and the long-distance transmission and the use of an increased number of intermediate connectors due to the high-output and low-loss design can be achieved, and besides. because of its highly thermally-resistant design, the optical connector can be installed at a high-temperature region, and can be installed in a narrow space as between the roof panels of the vehicle body or in the engine room.

As a result, there can be provided the on-vehicle optical connector in which the broad-band optical transmission can be effected, and the long-distance transmission and the use of an increased number of intermediate connectors due to the high-output and low-loss design can be achieved, and besides because of its highly thermally-resistant design, the optical connector can be installed at a high-temperature region.

### BRIEF DESCRIPTION OF THE DRAWINGS

The above objects and advantages of the present invention will become more apparent by describing in detail preferred exemplary embodiments thereof with reference to the accompanying drawings, wherein:

FIG. 1 is a side-elevational view showing one preferred embodiment of an optical connector of the invention;

FIG. 2 is a diagram showing characteristics of optical power of the optical connector of FIG. 1;

FIG. 3 is a plan view of a related optical connector;

FIG. 4 is a cross-sectional view showing a receiving device and its neighboring portions in FIG. 3;

FIG. 5 is a cross-sectional view showing a transmitting device and its neighboring portions in FIG. 3; and

FIG. 6 is a side-elevational view showing a related lens sleeve.

### DETAILED DESCRIPTION OF THE PREFERRED EMBODIMENTS

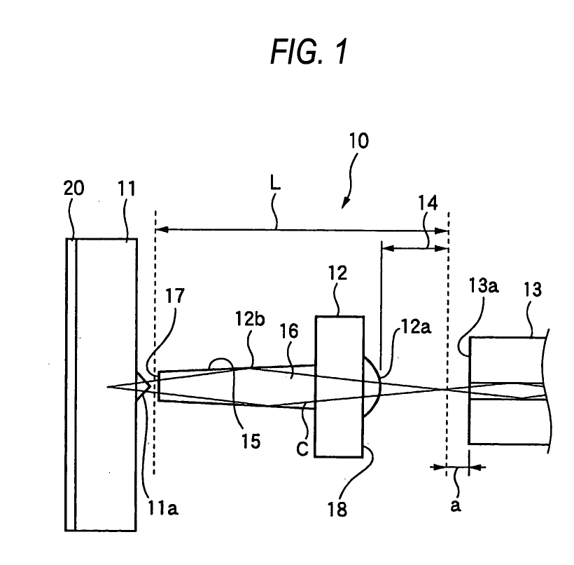

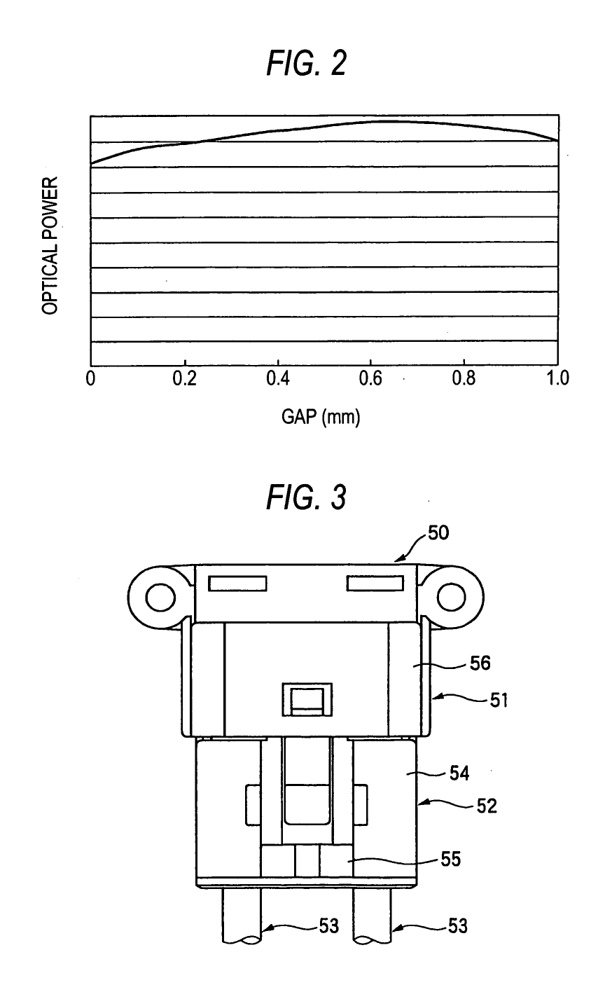

One preferred embodiment of an optical connector of the present invention will now be described in detail with reference to FIGS. 1 and 2. FIG. 1 is a plan view showing one preferred embodiment of the on-vehicle optical connector of the invention, and FIG. 2 is a diagram showing characteristics of optical power of the on-vehicle optical connector of FIG. 1. In FIG. 1, only important portions of the on-vehicle connector are shown, and the other portions have similar structures as those of the related connectors, and therefore specific description thereof will be omitted.

As shown in FIG. 1, the on-vehicle optical connector 10 of this embodiment mainly includes a light-emitting module 11, a lens sleeve 12, and a glass fiber 13.

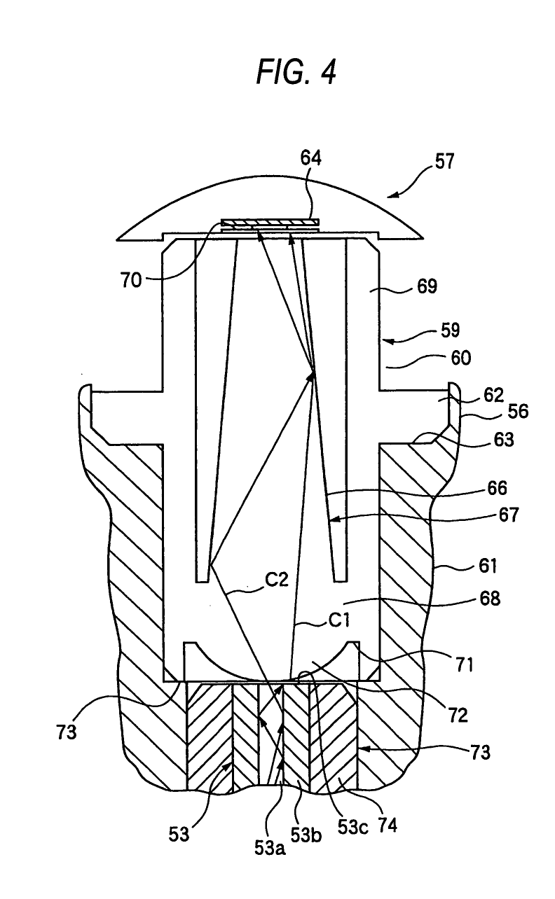

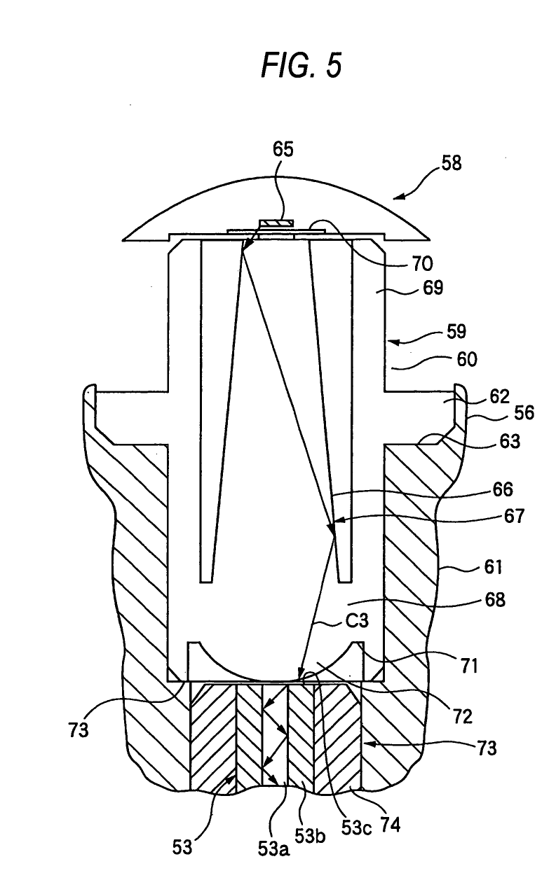

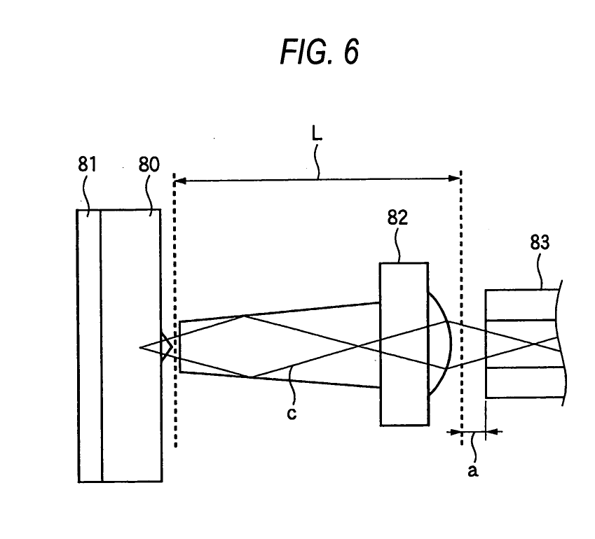

The light-emitting module 11 includes a light-emitting element such as a RCLED (Resonant Cavity Light Emitting Diode), a VCSEL (Vertical Cavity Surface Emitting Laser) and a LD (Laser Diode), and has a small light-emitting angle (emission angle) of 18 degrees, and this module 11 is fixedly mounted on a base plate 20, and is received in a receiving chamber (see FIG. 4).

The light-emitting module 11 converts an electrical signal into the optical signal, and has a light-emitting surface 11a for emitting the optical signal. Preferably, the emission angle of the light-emitting module 11 is in the range of between 15 degrees and 25 degrees, including 18 degrees.

The light-emitting module 11 has the small emission angle which is about ¼ of that of the related module, and therefore an optical output of high intensity can be obtained, and besides a broad-band design of the light source can be obtained.

Furthermore, the overall length of the lens sleeve 12 can be reduced, and a cylindrical portion 12b of the lens sleeve 12 can be reduced into a small diameter, and besides a radius of curvature of the lens can be reduced, thereby achieving the optimum design. With this construction, even when the glass fiber 13 of a small diameter is used, a large gap 14 is available within a space L given for the lens sleeve 12 which space is determined in connection with the design of the optical connector. Therefore, the angle of the light, entering the small-diameter glass fiber 13, can be reduced, and the uniform and efficient inputting of the light can be achieved.

The lens sleeve 12 includes a lens portion 12a and the cylindrical portion 12b. The cylindrical portion 12b is disposed close to the light-emitting module 11. The cylindrical portion 12b includes a light guide passage 16 of a truncated cone-shape which is decreasing in diameter gradually in a direction away from the glass fiber 13 toward the light-emitting module 11, and has a tapering side portion 15.

The lens sleeve 12 is formed into a small diameter and a compact size so that an optical signal, fed from the light-emitting module 11, can be made small in diameter, and can have condensing properties.

The lens sleeve 12 is molded of a cycloolefin synthetic resin having excellent heat resistance, transparent polycarbonate (PC), or polymethylmethacrylate (PMMA). The cycloolefin synthetic resin is one in which hydrocarbons have a cyclic structure, and no double bond is formed.

An end face 17 which is reduced in diameter at the light guide passage 16 of the lens sleeve 12 is larger than the light-emitting surface 11a of the light-emitting module 11. The end face 17 is disposed in opposed relation to the light-emitting surface 11a. Namely, the end face 17 is optically connected to the light-emitting module 11. The end face 17 defines the smaller end face of the light guide passage 16.

An end face 18 of the light guide passage 16, disposed remote from the end face 17, is disposed in opposed relation to an end face 13a of the glass fiber 13. Namely, the end face 18 is optically connected to the glass fiber 13. The lens portion 12b at the end face 18 is formed integrally with the light guide passage 16.

The lens portion 12a convexly projects from the end face 18 toward the glass fiber 13, and has a predetermined radius of curvature, and is formed, for example, into a spherical lens. The lens 12a projects from the end face 18 disposed close to the glass fiber 13.

The lens sleeve 12 is received in a support cylinder (see FIG. 4) such that the lens portion 12a is opposed to the end face 13a of the glass fiber 13 while the end face 17 is opposed to the light-emitting module 11. For example, a flange portion abuts against a step portion.

The glass fiber 13 is, for example, a HPCF (Hard Polymer Clad Fiber) (Core: 200 μm, Clad; 230 μm). A heat-resistance temperature of the glass fiber 13 is 125° C., and is much higher than a heat-resistance temperature of an ordinary optical fiber (made of a plastics material) which is 85° C.

As compared with an optical fiber made of a plastics material, the glass fiber 13 has a far larger communication capacity, and can easily transmit, for example, images, and the glass fiber 13 has a much smaller wire diameter than such a plastics-made optical fiber.

And besides, the glass fiber 13 can achieve a highly-efficient connection, and the glass fiber 13 is coupled to the lens sleeve 12 via the predetermined gap 14.

The gap 14 of a predetermined size is provided between the end face 18 of the lens sleeve 12 and the end face 13a of the glass fiber 13. It has been confirmed from results of tests that this optical connector can be used when the gap is in the range of between 0.2 mm and 0.8 mm. The glass fiber 13 has a much smaller wire diameter as compared with a plastics-made optical fiber, and therefore the gap 14 is an important element for effecting the uniform and efficient inputting of the light.

In the on-vehicle optical connector 10 having the above structure, when an optical signal is transmitted from the light-emitting module 11 to the glass fiber 13 via the lens sleeve 12, for example, an LED ray (or a laser beam) C, emitted from the light-emitting surface 11a of the light-emitting module 11, enters the lens sleeve 12 via the end face 17 of the lens sleeve 12.

Then, the LED ray C propagates in a diffused manner while repeatedly subjected to total reflection (since the side portion 15 of the light guide passage 16 is tapering (that is, gradually decreasing in diameter) toward the light-emitting module 11, and the side portion 15 is disposed in contact with an air layer), and reaches the lens portion 12a. Thereafter, the LED ray C is condensed by the lens portion 12a, and enters the glass fiber 13 via the end face 1 3a thereof.

As shown in FIG. 2, characteristics of the optical power in the on-vehicle optical connector 10 were examined while changing the value of a distance “a” in the range of from 0 mm to 1.0 mm.

As will be appreciated from the test results, loss of the power hardly occurs when the value of the distance “a” is in the range of from 0 mm to 1.0 mm, but the loss is the smallest particularly when the value of the distance “a” is in the range of between 0.2 mm and 0.8 mm (including 0.7 mm at which the power is the maximum).

In the above on-vehicle optical connector 10, exterior parts (including a connector housing, a ferrule and a support cylinder), used in the related optical connector employing plastics-made optical fibers, can be used. Therefore, it is not necessary to prepare new parts, and therefore the time and labor, required for producing the optical connector of the invention, will not increase. The glass fiber 13 is axially movable relative to the lens sleeve 12 in the range “a” shown in the drawings.

In this embodiment, the optical signal to be inputted into the lens sleeve 12 is reduced into a smaller diameter by the small numerical aperture of the light-emitting module 11.

Therefore, the cylindrical portion 12b of the lens sleeve 12 can be reduced into a small diameter by using the light-emitting module 11 having the small numeral aperture, and besides the radius of curvature of the lens is reduced, thereby achieving the optimum design. Therefore, even when the glass fiber 13 of a small diameter is used, the uniform and efficient inputting of the light can be achieved.

As a result, a broad-band optical transmission can be effected, and a long-distance transmission and the use of an increased number of intermediate connectors due to the high-output and low-loss design can be achieved, and besides because of its highly thermally-resistant design, the optical connector can be installed at a high-temperature region, and can be installed in a narrow space as between roof panels of a vehicle body or in an engine room.

There is used the light-emitting module 11 whose emission angle is in the range of between 15 degrees and 25 degrees, including 18 degrees.

Therefore, by using the light-emitting module 11 having the small numerical aperture in the range of between 15 degrees and 25 degrees (including 18 degrees), the cylindrical portion 12b of the lens sleeve 12 can be reduced into a small diameter, and the radius of curvature of the lens can be reduced, thereby achieving the optimum design. Therefore, even when the glass fiber of a small diameter is used, the uniform and efficient inputting of the light can be achieved.

As a result, the broad-band optical transmission can be effected, and the long-distance transmission and the use of an increased number of intermediate connectors due to the high-output and low-loss design can be achieved, and besides because of its highly thermally-resistant design, the optical connector can be installed at a high-temperature region, and can be installed in a narrow space as between the roof panels of the vehicle body or in the engine room.

The lens sleeve 12 is coupled to the glass fiber 13 via the gap 14 of the predetermined size.

Therefore, by using the light-emitting module 11 with the small numerical aperture and the lens sleeve 12 connected to the glass fiber via the gap 14, the cylindrical portion 12b of the lens sleeve 12 can be reduced into a small diameter, and besides the radius of curvature of the lens can be reduced, thereby achieving the optimum design. Therefore, even when the glass fiber of a small diameter is used, the uniform and efficient inputting of the light relative to the gap of the predetermined size can be achieved.

As a result, the broad-band optical transmission can be effected, and the long-distance transmission and the use of an increased number of intermediate connectors due to the high-output and low-loss design can be achieved, and besides because of its highly thermally-resistant design, the optical connector can be installed at a high-temperature region, and can be installed in a narrow space as between the roof panels of the vehicle body or in the engine room.

The on-vehicle optical fiber of the invention is not limited to the above embodiment, and suitable modifications and improvements can be made. For example, preferably, a combination of a light-receiving module, a lens sleeve and a glass fiber is similar in construction to the combination including the light-emitting module. The lens portion may be formed into an aspherical lens having a plurality of radii of curvature.

What is claimed is:

1. An optical connector, comprising:
a light emitting module, emitting an optical signal;
an optical fiber, propagating the optical signal; and
a lens sleeve, interposed between the light emitting module and the optical fiber so as to optically connect the light emitting module and the optical fiber,
wherein the light emitting module includes a light emitting element having a small emission angle.

2. The optical connector as set forth in claim 1, wherein the emission angle of the light emitting element is in the range of between 15 degrees and 25 degrees.

3. The optical connector as set forth in claim 1, wherein the optical fiber is movable relative to the lens sleeve within a predetermined range of a gap.

4. The optical connector as set forth in claim 2, wherein the emission angle of the light emitting element is around 18 degrees.

5. The optical connector as set forth in claim 1, wherein the optical fiber includes a glass fiber.

6. The optical connector as set forth in claim 1, wherein the light emitting element includes at least one of a resonant cavity light emitting diode, a vertical cavity surface emitting laser and a laser diode.
